(19) United States
(12) Patent Application Publication
(10) Pub. No.: US 2024/0354596 A1
(43) Pub. Date: Oct. 24, 2024

(54) Featureless Image Categorization and Recognition using Hybrid Artificial Intelligence (AI) and Image Structural Properties for System Performance Optimization

(71) Applicant: Bank of America Corporation, Charlotte, NC (US)

(72) Inventor: Maharaj Mukherjee, Poughkeepsie, NY (US)

(21) Appl. No.: 18/135,873

(22) Filed: Apr. 18, 2023

(51) Int. Cl. G06N 5/022; H04L 43/08

(52) U.S. Cl. CPC G06N 5/022; H04L 43/08

(57) ABSTRACT

A computing platform may train, using a plurality of historical thermal images, a thermal image classification model, which may configure the thermal image classification model to classify thermal images based on performance of systems represented by the thermal images. The computing platform may collect current system performance information for a first computing system. The computing platform may generate, using the current system performance information, a new thermal image, representative of the current system performance information. The computing platform may classify, using the thermal image classification model, the new thermal image. Based on the classification of the new thermal image, the computing platform may send one or more network action commands, which may cause a network traffic manager to redirect traffic from the first computing system to a second computing system.

### BACKGROUND

In some instances, images may include distinct features and feature boundaries. Such images may be easy to categorize using machine learning to search and find such features. Other images, however, may be amorphous or featureless. To be understood by a machine, such images must be tagged a priori. In some instances, however, images might not be tagged so easily. For example, many computer generated images might not be intended for human consumption. It may, therefore, be important to improve the classification process for such featureless images.

### SUMMARY OF THE INVENTION

Aspects of the disclosure provide effective, efficient, scalable, and convenient technical solutions that address and overcome the technical problems associated with system performance optimization. In accordance with one or more embodiments of the disclosure, a computing platform comprising at least one processor, a communication interface, and memory storing computer-readable instructions may train, using a plurality of historical thermal images, a thermal image classification model, which may configure the thermal image classification model to classify thermal images based on performance of systems represented by the thermal images. The computing platform may collect current system performance information for a first computing system. The computing platform may generate, using the current system performance information, a new thermal image, representative of the current system performance information. The computing platform may classify, using the thermal image classification model, the new thermal image. Based on the classification of the new thermal image, the computing platform may send one or more network action commands, which may cause a network traffic manager to redirect traffic from the first computing system to a second computing system.

In one or more instances, the computing platform may monitor a plurality of computing systems including the first computing system and the second computing system to detect historical system performance information. The computing platform may generate, using the historical system performance information, the plurality of historical thermal images. In one or more instances, the historical system performance information and the current system performance information may include one or more of: application performance information, system performance information, or test case results.

In one or more examples, training the thermal image classification model may include labelling the plurality of historical thermal images based on corresponding system performance, and training the thermal image classification model to identify correlations between the plurality of historical thermal images and the corresponding system performances. In one or more examples, classifying the current system performance information may include: comparing a plurality of image features of the new thermal image to the corresponding image features of the plurality of historical thermal images to identify a highest image matching score, and selecting a classification corresponding to the highest image matching score.

In one or more instances, the plurality of image features may include: image peaks and troughs, center of gravity, moment, and spatial frequency. In one or more instances, comparing the image peaks and troughs may include comparing one or more of: a number of the image peaks and troughs, or total areas of the image peaks and troughs.

In one or more examples, training the thermal image classification model may include initially applying equivalent weighting values to the plurality of image features. In one or more examples, the computing platform may update, using a dynamic feedback loop and based on the classification of the new thermal image, the thermal image classification model, which may include modifying the weighting values to weight at least one of the plurality of image features higher than at least one other feature of the plurality of image features.

In one or more instances, classifying the new thermal image may include assigning a performance score to the first computing system and classifying the first computing system based on the performance score. In one or more instances, the computing platform may identify whether or not the classification of the first computing system corresponds to a network action, where sending the one or more network action commands may be based on identifying that the classification of the first computing system corresponds to the network action.

### BRIEF DESCRIPTION OF DRAWINGS

The present disclosure is illustrated by way of example and not limited in the accompanying figures in which like reference numerals indicate similar elements and in which:

FIGS. 1A-1B depict an illustrative computing environment for performing featureless image categorization and recognition using hybrid artificial intelligence (AI) and image structural properties for system performance optimization in accordance with one or more example embodiments.

FIGS. 2A-2D depict an illustrative event sequence for performing featureless image categorization and recognition using hybrid artificial intelligence (AI) and image structural properties for system performance optimization in accordance with one or more example embodiments.

FIG. 3 depicts an illustrative user interface for performing featureless image categorization and recognition using hybrid artificial intelligence (AI) and image structural properties for system performance optimization in accordance with one or more example embodiments.

FIG. 4 depicts an illustrative method for performing featureless image categorization and recognition using hybrid artificial intelligence (AI) and image structural properties for system performance optimization in accordance with one or more example embodiments.

FIGS. 5-10B depict illustrative diagrams depicting performing featureless image categorization and recognition using hybrid artificial intelligence (AI) and image structural properties for system performance optimization in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

The following description relates to using hybrid artificial intelligence to perform featureless image categorization and recognition for system optimization. For example, most images that may be used for human consumption may come with distinct features and feature boundaries, such as a human face, car, dog, ship, boat, flower, or the like. These may be easy to categorize by applying machine learning to these features.

On the other hand, there are images that may be amorphous or featureless. Some examples of these kind of images are fire, snow, water, grassy fields, etc. Though humans may identify these images easily, such images must be tagged a priori for a machine to understand them.

In fact, the concept behind CAPTCHA is based on creating featureless or amorphous images that cannot be distinguished by a machine easily.

However, not all images can be tagged so easily. Besides, many computer generated images might not be used for human consumption. For example, a system wide technology infrastructure monitoring system may generate a heatmap for the overall system health for every second. It may be advantageous to enable a computer to identify system anomalies and abnormalities based on these automatic generated images, and to alert a human operator as needed.

Similar examples may be described in other areas as well, such as traffic patterns, stock tickers, weather patterns, and/or other fields where the machine generated patterns are both amorphous and featureless.

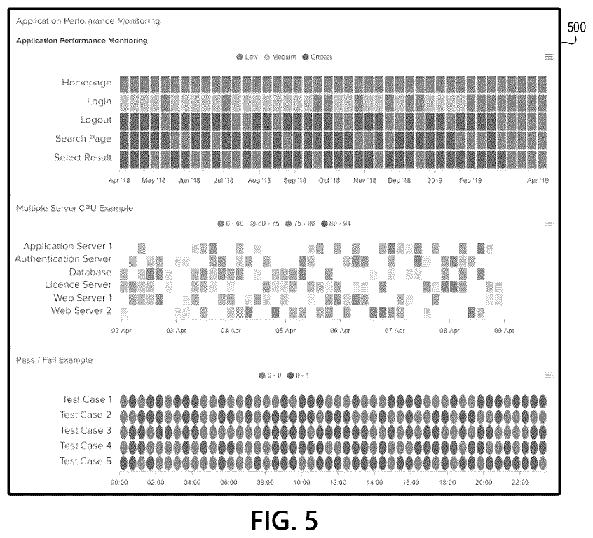

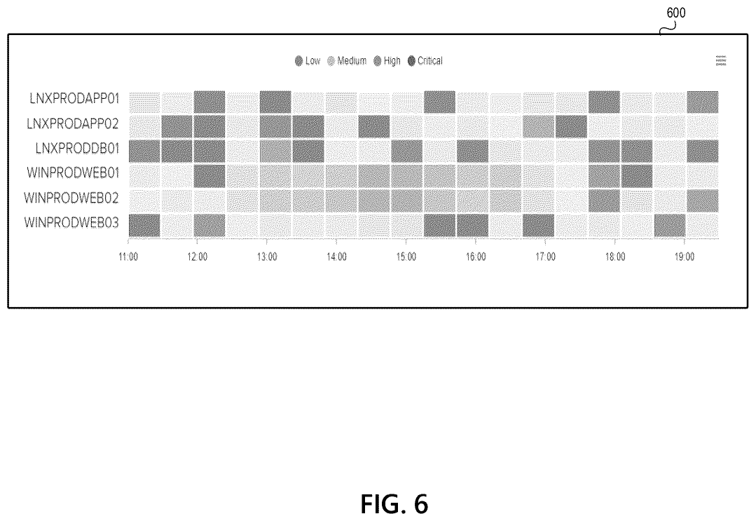

It may also be impossible for a human to know a priori which images are similar so that they may be tagged using the same tag. For example, in the case of a heatmap of a current status of systems (see FIGS. 5 and 6), it may be impossible for a human to categorize images without any prior information as to which one is normal and which one is abnormal or an anomaly or something the system has not encountered before.

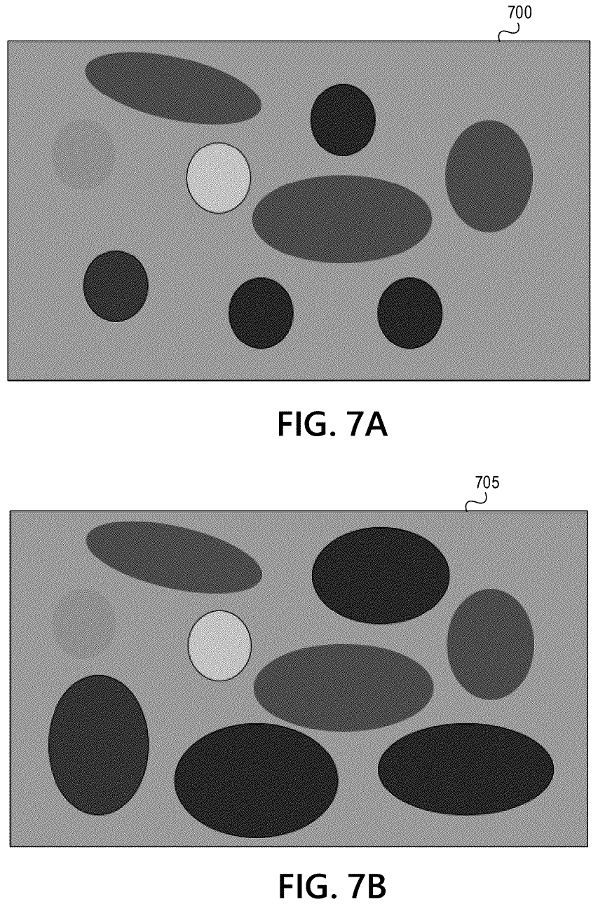

Accordingly, as described herein, images may be distinguished by various structural properties. For example, as shown in FIGS. 7A-7B, images may be distinguished by their peaks and troughs (e.g., a number of the peaks and troughs, and/or their total areas). As shown in FIGS. 7A-7B, two images may have the same number of peaks and troughs, but they may have different area coverages.

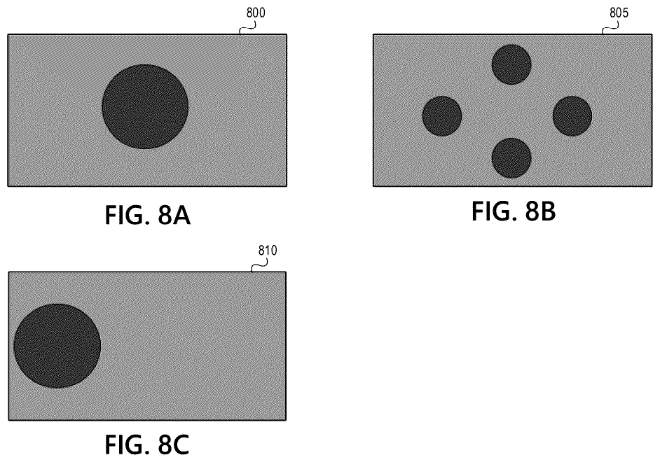

Additionally or alternatively, images may be distinguished by their centers of gravity, as shown in FIGS. 8A-8C, which show how skewed images may be in terms of their peaks and valleys. For example, FIGS. 8A and 8B, illustrate two images with the same center of gravity but with different numbers of peaks. FIGS. 8A and 8C illustrate two images with the same number of peaks and peak areas, but different centers of gravity.

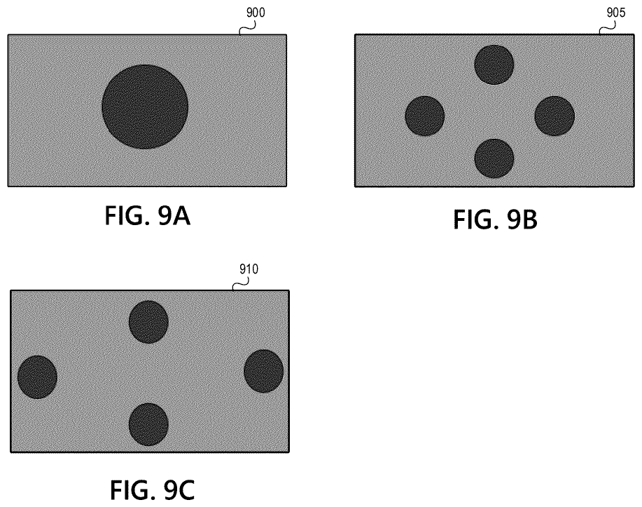

Additionally or alternatively, images may be distinguished by their moments, which describe how far from the center of gravity the peaks and troughs of the images are distributed. For example, FIGS. 9A-9C illustrate three images with the same center of gravity, but different moments (e.g., where the moment increases as the images progress).

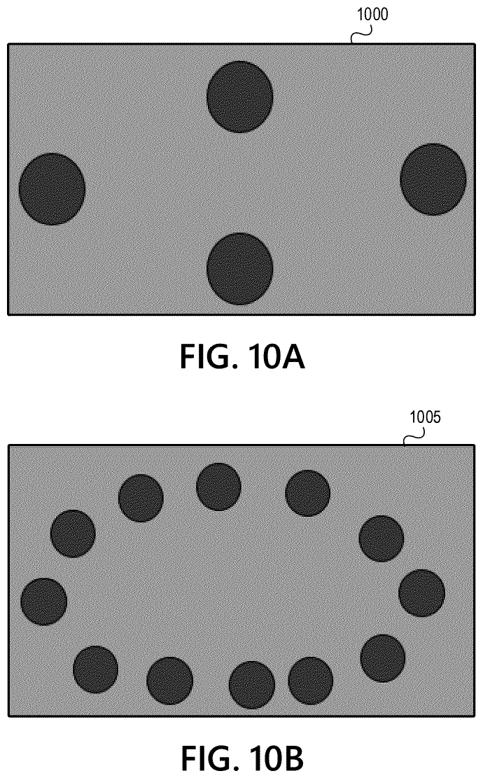

Additionally or alternatively, images may be distinguished by the spatial frequency (as shown in FIGS. 10A-10B), which may capture the variations of the peaks and valleys of images, and how quickly they vary over both the x and y axes. FIGS. 10A-10B show two images with the same center of gravity and moments, but with different frequencies (e.g., the frequency shown in FIG. 10B is higher).

As described herein, a hybrid AI method may be used, that may include both rule based and statistical machine learning methods. A weighted scale of the structural properties may be used to determine similar sets of images. The scale may be initially set up based on a rule, but the weights may be adjusted using a deep learning method for reducing error.

The method may use both supervised learning (where a certain set of images are pre-categorized), and/or unsupervised learning (e.g., with both known or unknown sets of categories or clusters). Additional structural properties may also be added for better accuracy.

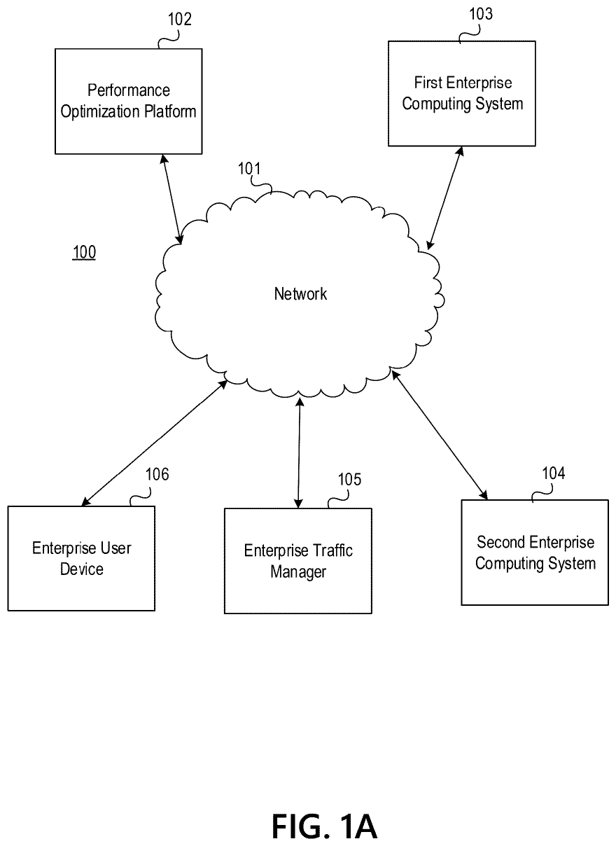

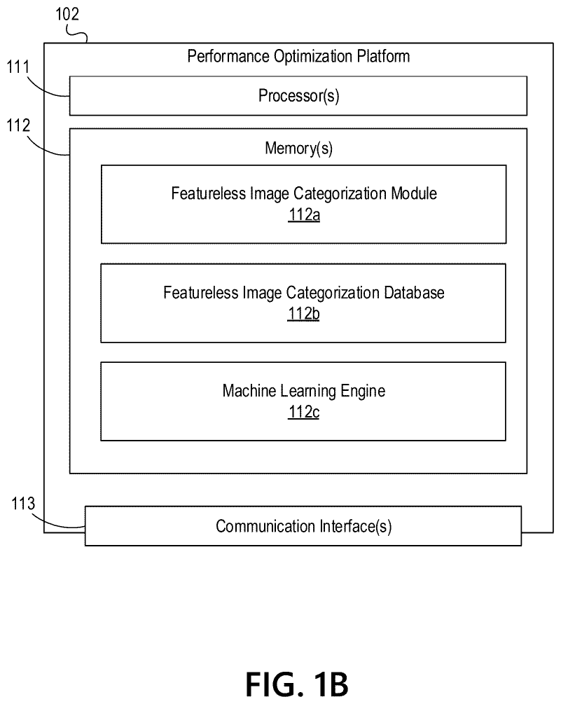

FIGS. 1A-1B depict an illustrative computing environment for performing featureless image categorization and recognition using hybrid artificial intelligence (AI) and image structural properties for system performance optimization in accordance with one or more example embodiments. Referring to FIG. 1A, computing environment 100 may include one or more computer systems. For example, computing environment 100 may include a performance optimization platform 102, first enterprise computing system 103, second enterprise computing system 104, enterprise traffic manager 105, and enterprise user device 106.

Performance optimization platform 102 may include one or more computing devices and/or other computer components (e.g., processors, memories, communication interfaces, or the like). For example, the performance optimization platform 102 may be configured to train, host, and/or otherwise maintain a thermal image classification model, which may be used to classify thermal images for the purpose of identifying system health. In these instances, the performance optimization platform 102 may be configured to cause the performance of network actions based on the classification.

First enterprise computing system 103 may include one or more computing devices and/or other computer components (e.g., processors, memories, communication interfaces, or the like). For example, first enterprise computing system 103 may be configured to execute one or more software applications and/or execute other functions. In some instances, the first enterprise computing system 103 may be an application server, authentication server, data storage system, license server, web server, and/or other computing system.

Second enterprise computing system 104 may include one or more computing devices and/or other computer components (e.g., processors, memories, communication interfaces, or the like). For example, second enterprise computing system 104 may be configured to execute one or more software applications and/or execute other functions. In some instances, the second enterprise computing system 104 may be an application server, authentication server, data storage system, license server, web server, and/or other computing system. In some instances, the second enterprise computing system 104 may be the same or a different type of system than the first enterprise computing system 103.

Although two enterprise computing systems are illustrated, any number of such enterprise computing systems may be implemented without departing from the scope of the disclosure.

Enterprise traffic manager 105 may include one or more computing devices and/or other computer components (e.g., processors, memories, communication interfaces, or the like). In some instances, the enterprise traffic manager 105 may be configured to direct traffic to enterprise computing systems (e.g., first enterprise computing system 103, second enterprise computing system 104, or the like) for processing, storage, and/or other functions. In some instances, the enterprise traffic manager 105 may receive commands from the performance optimization platform 102, which may cause the enterprise traffic manager 105 to direct traffic in a particular way.

Enterprise user device 106 may be a device (e.g., laptop computer, desktop computer, smartphone, tablet, and/or other devices) configured for use in the execution of network actions. For example, the enterprise user device 106 may be configured to communicate with the performance optimization platform 102 to receive network action information and to provide approval to execute corresponding network actions. In some instances, the enterprise user device 106 may be configured to display graphical user interfaces (e.g., approval interfaces, or the like). Any number of such user devices may be used to implement the techniques described herein without departing from the scope of the disclosure. For example, a plurality of enterprise user devices may be used to provide consensus approval.

Computing environment 100 also may include one or more networks, which may interconnect performance optimization platform 102, first enterprise computing system 103, second enterprise computing system 104, enterprise traffic manager 105, and enterprise user device 106. For example, computing environment 100 may include a network 101 (which may interconnect, e.g., performance optimization platform 102, first enterprise computing system 103, second enterprise computing system 104, enterprise traffic manager 105, and enterprise user device 106).

In one or more arrangements, performance optimization platform 102, first enterprise computing system 103, second enterprise computing system 104, enterprise traffic manager 105, and enterprise user device 106 may be any type of computing device capable of receiving a user interface, receiving input via the user interface, and communicating the received input to one or more other computing devices. For example, performance optimization platform 102, first enterprise computing system 103, second enterprise computing system 104, enterprise traffic manager 105, enterprise user device 106, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of performance optimization platform 102, first enterprise computing system 103, second enterprise computing system 104, enterprise traffic manager 105, and/or enterprise user device 106 may, in some instances, be special-purpose computing devices configured to perform specific functions.

Referring to FIG. 1B, performance optimization platform 102 may include one or more processors 111, memory 112, and communication interface 113. A data bus may interconnect processor 111, memory 112, and communication interface 113. Communication interface 113 may be a network interface configured to support communication between performance optimization platform 102 and one or more networks (e.g., network 101, or the like). Memory 112 may include one or more program modules having instructions that when executed by processor 111 cause performance optimization platform 102 to perform one or more functions described herein and/or one or more databases that may store and/or otherwise maintain information which may be used by such program modules and/or processor 111. In some instances, the one or more program modules and/or databases may be stored by and/or maintained in different memory units of performance optimization platform 102 and/or by different computing devices that may form and/or otherwise make up performance optimization platform 102. For example, memory 112 may have, host, store, and/or include featureless image categorization module 112a, featureless image categorization database 112b, and machine learning engine 112c. Featureless image categorization module 112a may have instructions that direct and/or cause performance optimization platform 102 to execute advanced techniques for dynamically classifying thermal images to monitor system health, and/or performing other actions. Featureless image categorization database 112b may store information used by featureless image categorization module 112a, and/or other modules in dynamically classifying thermal images to monitor system health, and/or performing other actions. Machine learning engine 112c may be used to train, deploy, and/or otherwise refine models used to support functionality of the featureless image categorization module 112a through both initial training and one or more dynamic feedback loops, which may, e.g., enable continuous improvement of the performance optimization platform 102 and further optimize the classification of thermal images for use in monitoring system health and status.

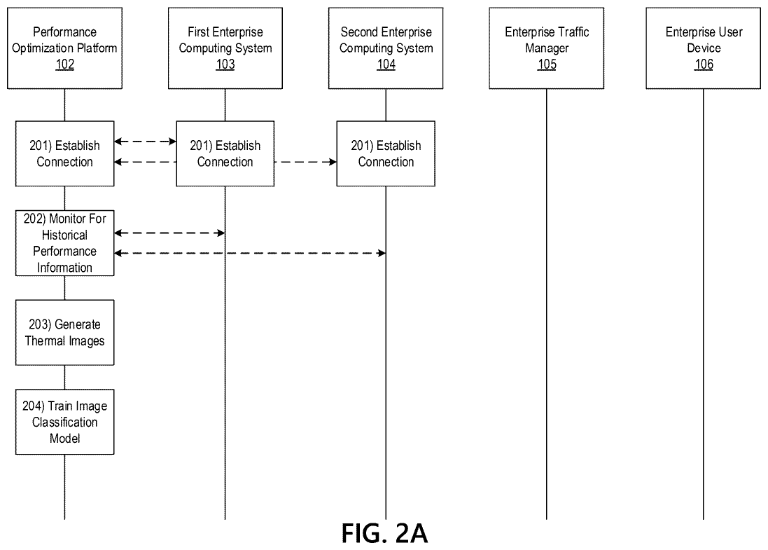

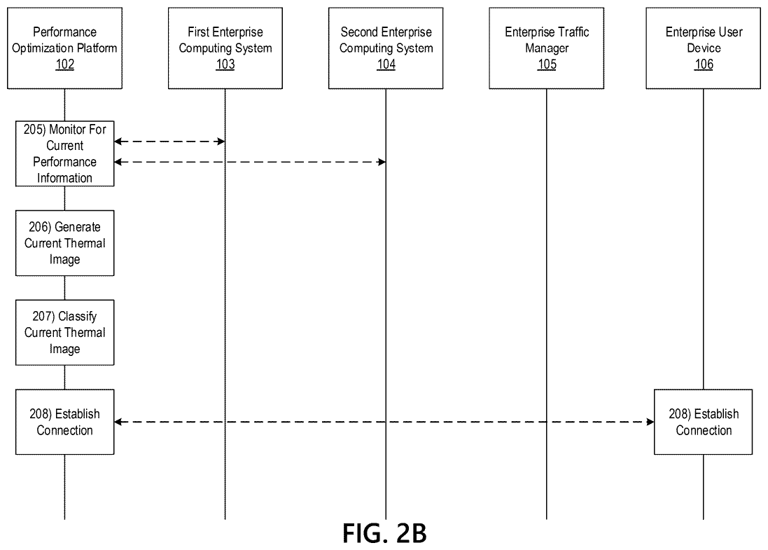

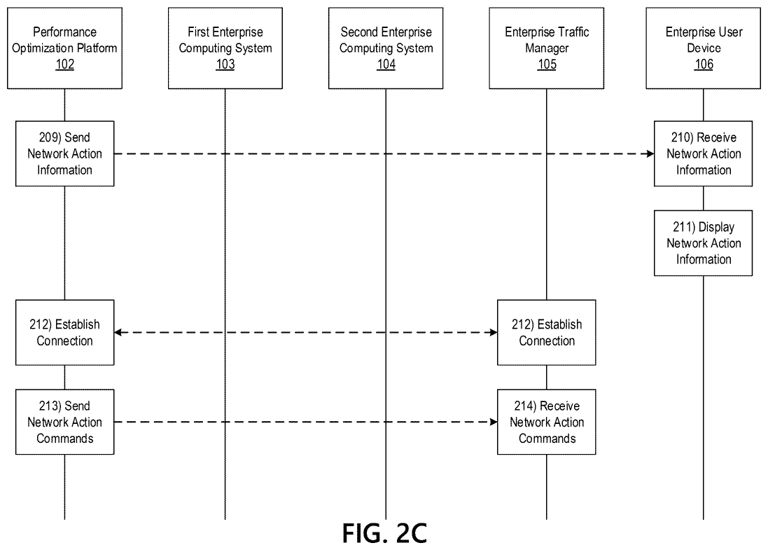

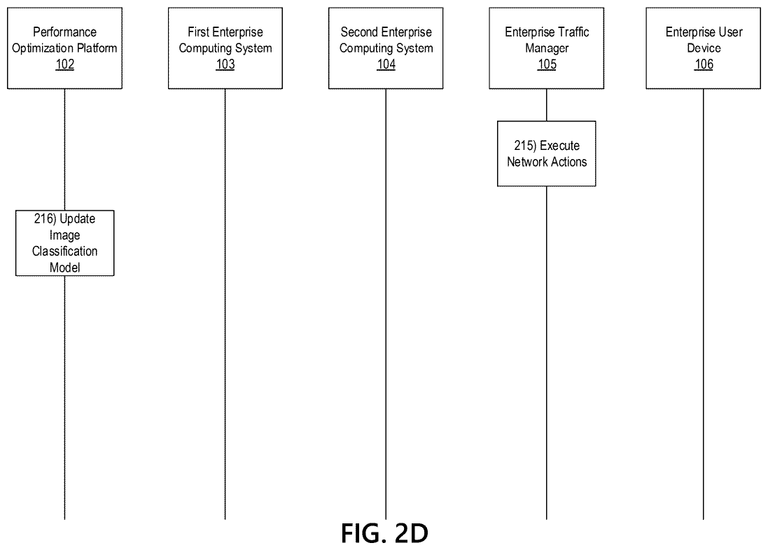

FIGS. 2A-2D depict an illustrative event sequence for performing featureless image categorization and recognition using hybrid artificial intelligence (AI) and image structural properties for system performance optimization in accordance with one or more example embodiments. Referring to FIG. 2A, at step 201, the performance optimization platform 102 may establish connections with the first enterprise computing system 103 and the second enterprise computing system 104. For example, the performance optimization platform 102 may establish first and/or second connections with the first enterprise computing system 103 and the second enterprise computing system 104, respectively. In some instances, the performance optimization platform 102 may identify whether or not connections are already established with the first enterprise computing system 103 and/or the second enterprise computing system 104. If connections are already established with the first enterprise computing system 103 and/or the second enterprise computing system 104, the performance optimization platform 102 might not re-establish the connections. Otherwise, if connections are not yet established with the first enterprise computing system 103 and/or the second enterprise computing system 104 may establish the first and/or second wireless data connections as described herein.

At step 202, the performance optimization platform 102 may monitor the first enterprise computing system 103 and the second enterprise computing system 104 to detect historical performance information. For example, the performance optimization platform 102 may monitor the first enterprise computing system 103 and the second enterprise computing system 104 via the communication interface 113 and while the first and/or second wireless data connections are established. For example, in monitoring for the historical performance information, the performance optimization platform 102 may collect system performance information (e.g., processing speed, available memory, available computer processing units (CPU), number of jobs, failure rates, and/or other information), application information (e.g., processing speed, failure rates, runtime errors, and/or other information), test results (e.g., pass, fail, and/or other results), and/or other information corresponding to the first enterprise computing system 103 and/or second enterprise computing system 104.

At step 203, the performance optimization platform 102 may generate historical thermal images based on the historical performance information collected at step 202. For example, the performance optimization platform 102 may generate thermal images similar to those shown in diagram 500 of FIG. 5, which shows, for example, application performance over time, server performance over time, and pass/fail test results over time.

In some instances, to generate the historical thermal images, the performance optimization platform 102 may normalize the historical performance information (e.g., to create values between 0 and 1). In doing so, different parameters may be compared on a uniform scale.

In some instances, the performance optimization platform 102 may classify performance of the historical performance information based on a categorization (e.g., low, medium, critical, or the like), a performance score range (e.g., 0-60, 60-75, 75-80, 80-94, or the like), a binary representation of pass versus fail (e.g., 0 or non-zero, or the like), and/or otherwise. In some instances, the performance optimization platform 102 may perform such categorization based on one or more performance metrics (e.g., processing speed, or the like). Once the performance has been classified, it may be represented over time using different colors/shades, as shown in diagram 500 of FIG. 5. This is further illustrated, for example, in diagram 600 of FIG. 6, which shows the performance of various processors over time.

With further reference to FIG. 2A, at step 204, once the historical thermal images have been generated, the performance optimization platform 102 may train an image classification model. For example, in some instances, the performance optimization platform 102 may feed labelled historical thermal images into the image classification model (e.g., labelled based on a threat level, likelihood of failure, or the like). In doing so, the performance optimization platform 102 may train the image classification model to establish stored correlations between the historical thermal images and their corresponding label information, which may, e.g., enable the image classification model to establish a correlation between input thermal images and corresponding threat levels so as to classify such thermal images based on the threat levels (e.g., to optimize system performance, in terms of processing speed, outage rates, failure rates, available CPU, and/or other criteria). In some instances, these correlations may include exact matches between thermal images, and thus an exact threat level may be identified. For example, the performance optimization platform 102 may train the image classification model to identify matches between various features of the thermal images such as image peaks and troughs (e.g., number of peaks and troughs, total areas of peaks and troughs, or the like), center of gravity, moment, spatial frequency, and/or other features.

For example, as shown in FIGS. 7A-7B, two images may have the same number of peaks and troughs (e.g., diagrams 700 and 705 may include the same number of shapes), but the total areas of these shapes may be different. In these instances, the image classification model may be trained to distinguish between these thermal images.

As another example, as shown in FIGS. 8A-8C, two images may have the same center of gravity, but a different number of peaks (see e.g., diagrams 800 and 805). Alternatively, two images may have the same number of peaks, but may have a different center of gravity (see e.g., diagrams 800 and 810). In these instances, the image classification model may be trained to distinguish between these thermal images.

As another example, as shown in FIGS. 9A-9C, images may have the same center of gravity, but may have different moments (e.g., the moment in diagram 910 may be larger than the moment in diagram 905, which may be larger than the moment in diagram 900). In these instances, the image classification model may be trained to distinguish between these thermal images.

As another example, as shown in FIGS. 10A-10B, images may have the same center of gravity and moments, but may have different spatial frequencies (e.g., diagram 1005 shows a higher frequency than diagram 1000). In these instances, the image classification model may be trained to distinguish between these thermal images.

Although the features of peaks and troughs, moment, center of gravity, and spatial frequency are explicitly described above, this is for illustrative purposes, and other features may be used without departing from the scope of the disclosure.

In some instances, the image classification model may be trained to generate an image matching score for each feature, and then combine the various feature image matching scores to create an overall image matching score. In these instances, the smaller the discrepancy between the above described features of an input image and a previously classified image, the higher the matching score, and vice versa.

In some instances, these features may be weighted evenly (e.g., overall image matching score=(.25*peaks and troughs score)+(.25*center of gravity score)+(.25*moment score)+(.25*spatial frequency score)). Alternatively, the features may be weighted differently. In some instances, the features may initially be weighted evenly, and the weighting may be dynamically adjusted over time (e.g., via a dynamic feedback loop) to weight features higher that may be identified as higher indicators of matching images.

In some instances, the performance optimization platform 102 may train the image classification model to identify non-exact (e.g., fuzzy) matches based on a certain percentage of matching thermal image features (e.g., despite an exact match not being available). For example, the performance optimization platform 102 may predict the fuzzy match in the event that an exact match is not identified. In some instances, the performance optimization platform 102 may generate a similarity score between various features of the input thermal images and the historical thermal images. If the similarity score exceeds a predetermined similarity threshold, the performance optimization platform 102 may identify a fuzzy match. In these instances, if a corresponding classification is ultimately identified through a fuzzy match, the performance optimization platform 102 may train the image classification model to identify a correlation between the corresponding thermal image and the classification (e.g., by refining the model using a dynamic feedback loop, as is described further below with regard to step 216). In doing so, the performance optimization platform 102 may conserve computing resources by avoiding an extensive alternative evaluation to identify outputs where no exact match is identified.

In some instances, in training the image classification model, the performance optimization platform 102 may train a supervised learning model. For example, the performance optimization platform 102 may train one or more of: decision trees, ensembles (e.g., boosting, bagging, random forest, or the like), neural networks, linear regression models, artificial neural networks, logistic regression models, support vector machines, and/or other supervised learning models. In some instances, the performance optimization platform 102 may train the container configuration generation model using one or more unsupervised learning techniques (e.g., classification, regression, clustering, anomaly detection, artificial neutral networks, and/or other supervised models/techniques). Accordingly, the image classification model may ultimately be trained to classify thermal images based on their similarity to historical thermal images, which may, e.g., effectively label the new thermal images with the corresponding classification of the matching historical thermal images (which may, e.g., be indicative of system/application performance, such as a label of “low,” “medium,” or “critical” threat of system failure).

Referring to FIG. 2B, at step 205, the performance optimization platform 102 may monitor the first enterprise computing system 103 and/or the second enterprise computing system 104 to detect current performance information. For example, the performance optimization platform 102 may detect current information similar to the historical performance information collected at step 202.

At step 206, the performance optimization platform 102 may generate a current thermal image based on the current performance information. For example, the performance optimization platform 102 may perform similar actions to those described above at step 203 with regard to generation of the historical thermal images.

At step 207, the performance optimization platform 102 may input the current thermal image, generated at step 206, into the image classification model to produce a classification for the current thermal image. For example, the image classification model may compare features (e.g., peaks and troughs, center of gravity, moment spatial frequency, and/or other features) of the current thermal image to those of the historical thermal images stored in the image classification model. If the image classification model identifies that a similarity or matching score with a particular historical thermal image exceeds a predetermined matching threshold, the classification model may classify the current thermal image along with the matching historical thermal image (which may, e.g., include assigning a label based on the classification). For example, the image classification model may classify the current thermal image as indicating a low likelihood of failure, medium likelihood of failure, or critical state (e.g., where likelihood of failure may be high). Additionally or alternatively, the image classification model may classify the current thermal image with a performance score (e.g., a score of the corresponding historical thermal image), which may, e.g., indicate a likelihood of failure and/or other system performance, and where a lower score may indicate worse performance than a higher score.

In some instances, the classification may also include a corresponding network action (e.g., used to remedy a corresponding system/application failure in the previous scenario). For example, the classification may include a network action such as redirect network traffic, reduce system load, halt processing, send alerts, provide administrator feedback, and/or other actions.

In some instances, where the classification is label based (e.g., low risk, medium risk, high risk, or the like), the performance optimization platform 102 may proceed accordingly based on the classification. For example, if the classification is low risk, the performance optimization platform 102 may proceed to step 216. If the classification is medium risk, the performance optimization platform 102 may proceed to step 208. If the classification is high risk, the performance optimization platform 102 may proceed to step 212.

In some instances, where the classification is score based, the performance optimization platform 102 may compare the performance score to one or more thresholds and proceed accordingly. For example, if the performance optimization platform 102 identifies that the performance score is below a first threshold, the performance optimization platform may proceed to step 212. If the performance score is equal to or greater than the first threshold, but less than a second, higher threshold, the performance optimization platform 102 may proceed to step 208. If the performance score is equal to or greater than the second threshold, the performance optimization platform 102 may proceed to step 216.

Additionally or alternatively, the performance optimization platform 102 may identify a confidence score corresponding to the classification, and may compare the confidence score to a predetermined confidence threshold. In these instances, if the confidence threshold is met or exceeded, the performance optimization platform 102 may proceed to step 212 (e.g., even in scenarios described above where the performance optimization platform 102 may otherwise proceed to step 208 to request approval). Similarly, if the confidence threshold is not met or exceeded, the performance optimization platform 102 may proceed to step 208 (e.g., even in scenarios described above where the performance optimization platform 102 may otherwise proceed to step 212 to send network action commands).

At step 208, the performance optimization platform 102 may establish a connection with the enterprise user device 106. For example, the performance optimization platform 102 may establish a third wireless data connection with the enterprise user device 106 to link the performance optimization platform 102 with the enterprise user device 106 (e.g., in preparation for sending network action information). In some instances, the performance optimization platform 102 may identify whether or not a connection is already established with the enterprise user device 106. If a connection is already established with the enterprise user device 106, the performance optimization platform 102 might not re-establish the connection. Otherwise, the performance optimization platform 102 may establish the third wireless data connection as described herein.

Referring to FIG. 2C, at step 209, the performance optimization platform 102 may send network action information to the enterprise user device 106. For example, the performance optimization platform 102 may send information identifying the classification of a system of the current thermal image (e.g., the first enterprise computing system 103), and a corresponding network action to be performed. In some instances, the performance optimization platform 102 may send the network action information via the communication interface 113 and while the third wireless data connection is established. In some instances, the performance optimization platform 102 may also send one or more commands directing the enterprise user device 106 to display the network action information (e.g., to obtain approval).

At step 210, the enterprise user device 106 may receive the network action information sent at step 209. For example, the enterprise user device 106 may receive the network action information while the third wireless data connection is established. In some instances, the enterprise user device 106 may also receive the one or more commands directing the enterprise user device 106 to display the network action information.

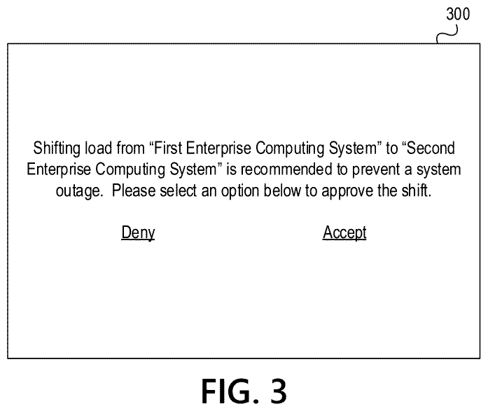

At step 211, based on or in response to the one or more commands directing the enterprise user device 106 to display the network action information, the enterprise user device 106 may display the network action information. For example, the enterprise user device 106 may display a graphical user interface similar to graphical user interface 300, which is shown in FIG. 3. For example, the enterprise user device 106 may display an interface recommending to shift load from first enterprise computing system 103 to second enterprise computing system 104, and prompting for acceptance of the network action. Based on receiving selection of an approval interface element, the enterprise user device 106 may send approval information to the performance optimization platform 102, which may, e.g., trigger the performance of step 212. Otherwise, if a denial interface element is selected, the event sequence may return to step 205 to collect and analyze updated system/application performance information. Although such approval is illustrated as input received at a single enterprise user device 106, in some instances, input may be solicited by a number of different enterprise user devices (e.g., to obtain consensus approval) without departing from the scope of the disclosure.

At step 212, the performance optimization platform may establish a connection with the enterprise traffic manager 105. For example, the performance optimization platform 102 may establish a fourth wireless data connection with the enterprise traffic manager 105 to link the performance optimization platform 102 to the enterprise traffic manager 105 (e.g., in preparation for sending network action commands). In some instances, the performance optimization platform 102 may identify whether or not a connection is already established with the enterprise traffic manager 105. If a connection is already established with the enterprise traffic manager 105, the performance optimization platform 102 might not re-establish the connection. If a connection is not yet established with the enterprise traffic manager 105, the performance optimization platform 102 may establish the fourth wireless data connection as described herein.

At step 213, the performance optimization platform 102 may send one or more network action commands to the enterprise traffic manager 105. For example, the performance optimization platform 102 may send commands directing the enterprise traffic manager 105 to re-route traffic for the first enterprise computing system 103 to the second enterprise computing system 104. In some instances, the performance optimization platform 102 may send the one or more network action commands to the enterprise traffic manager 105 while the fourth wireless data connection is established.

At step 214, the enterprise traffic manager 105 may receive the one or more network action commands sent at step 213. In some instances, the enterprise traffic manager 105 may receive the network action commands while the fourth wireless data connection is established.

Referring to FIG. 2D, at step 215, based on or in response to the one or more network action commands received at step 214, the enterprise traffic manager 105 may execute one or more network actions. For example, the enterprise traffic manager 105 may update a network routing policy to redirect traffic to the second enterprise computing system 104 rather than the first enterprise computing system 103.

Although the network actions commands are illustrated as being sent to an enterprise traffic manager 105, such commands may be sent to a different computing system (e.g., first enterprise computing system 103, second enterprise computing system 104, and/or other systems) and may direct other actions to be performed (e.g., to avoid system failure/outage, or to improve functionality/efficiency) without departing from the scope of the disclosure.

At step 216, the performance optimization platform 102 may update the image classification model based on the classification performed at step 207. In doing so, the performance optimization platform 102 may continue to refine the image classification model using a dynamic feedback loop, which may, e.g., increase the accuracy and effectiveness of the image classification model in classifying images to prevent system/application failures/outages and/or to otherwise improve performance. For example, the performance optimization platform 102 may feed the classification information and/or network action into the image classification model.

In some instances, the performance optimization platform 102 may continuously refine the image classification model. In some instances, the performance optimization platform 102 may maintain an accuracy threshold for the image classification model, and may pause refinement (through the dynamic feedback loops) of the image classification model if the corresponding accuracy is identified as greater than the corresponding accuracy threshold. Similarly, if the accuracy fails to be equal or less than the accuracy threshold, the performance optimization platform 102 may resume refinement of the image classification model through the dynamic feedback loop.

Although the above described event sequence primarily describes the use of the image classification model to classify thermal images for system/application performance optimization, such a model may be used to classify other featureless images (e.g., related to traffic patterns, stock tickers, weather patterns, and/or other fields) and/or initiate other actions without departing from the scope of the disclosure.

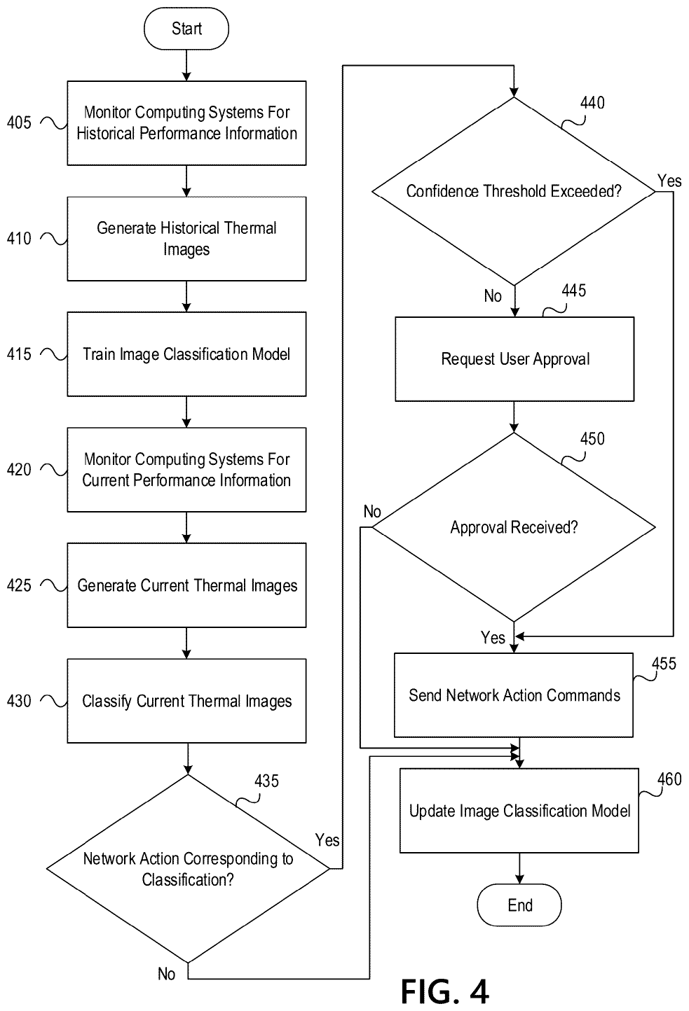

FIG. 4 depicts an illustrative method for performing featureless image categorization and recognition using hybrid artificial intelligence (AI) and image structural properties for system performance optimization in accordance with one or more example embodiments. Referring to FIG. 4, at step 405, a computing platform comprising a memory, one or more processors, and a communication interface may monitor computing systems for historical performance information. At step 410, the computing platform may generate historical thermal images using the historical performance information. At step 415, the computing platform may train an image classification model using the historical performance information. At step 420, the computing platform may monitor the computing systems for current performance information. At step 425, the computing platform may generate a current thermal image from the current performance information. At step 430, the computing platform may classify the current thermal image. At step 435, the computing platform may identify whether there is a network action corresponding to the classification. If there is a network action, the computing platform may proceed to step 440. Otherwise, the computing platform may proceed to step 460.

At step 440, the computing platform may identify whether or not a confidence score corresponding to the classification exceeds a confidence threshold. If the confidence threshold is not met or exceeded, the computing platform may proceed to step 445. If the confidence threshold is met or exceeded, the computing platform may proceed to step 455.

At step 445, the computing platform may request user approval to execute the network actions. At step 450, the computing platform may identify whether or not approval was received to execute the network actions. If approval was not received, the computing platform may proceed to step 460. Otherwise, if approval was received, the computing platform may proceed to step 455.

At step 455, the computing platform may send one or more network action commands. At step 460, the computing platform may update the image classification model.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
train, using a plurality of historical thermal images, a thermal image classification model, wherein training the thermal image classification model configures the thermal image classification model to classify thermal images based on performance of systems represented by the thermal images;
collect current system performance information for a first computing system;
generate, using the current system performance information, a new thermal image, representative of the current system performance information;
classify, using the thermal image classification model, the new thermal image; and
based on the classification of the new thermal image, send one or more network action commands, wherein sending the one or more network action commands causes a network traffic manager to redirect traffic from the first computing system to a second computing system.

2. The computing platform of claim 1, wherein the memory stores additional computer-readable instructions that, when executed by the at least one processor, cause the computing platform to:
monitor a plurality of computing systems including the first computing system and the second computing system to detect historical system performance information; and
generate, using the historical system performance information, the plurality of historical thermal images.

3. The computing platform of claim 2, wherein the historical system performance information and the current system performance information comprise one or more of: application performance information, system performance information, or test case results.

4. The computing platform of claim 1, wherein training the thermal image classification model comprises labelling the plurality of historical thermal images based on corresponding system performance, and training the thermal image classification model to identify correlations between the plurality of historical thermal images and the corresponding system performances.

5. The computing platform of claim 1, wherein classifying the current system performance information comprises:
comparing a plurality of image features of the new thermal image to the corresponding image features of the plurality of historical thermal images to identify a highest image matching score, and
selecting a classification corresponding to the highest image matching score.

6. The computing platform of claim 5, wherein the plurality of image features comprise: image peaks and troughs, center of gravity, moment, and spatial frequency.

7. The computing platform of claim 6, wherein comparing the image peaks and troughs comprises comparing one or more of: a number of the image peaks and troughs, or total areas of the image peaks and troughs.

8. The computing platform of claim 5, wherein training the thermal image classification model comprises initially applying equal weighting values to the plurality of image features.

9. The computing platform of claim 8, wherein the memory stores additional computer-readable instructions that, when executed by the at least one processor, cause the computing platform to:
update, using a dynamic feedback loop and based on the classification of the new thermal image, the thermal image classification model, wherein updating the thermal image classification model includes modifying the weighting values to weight at least one of the plurality of image features higher than at least one other feature of the plurality of image features.

10. The computing platform of claim 1, wherein classifying the new thermal image comprises assigning a performance score to the first computing system and classifying the first computing system based on the performance score.

11. The computing platform of claim 10, wherein the memory stores additional computer-readable instructions that, when executed by the at least one processor, cause the computing platform to:
identify whether or not the classification of the first computing system corresponds to a network action, wherein sending the one or more network action commands is based on identifying that the classification of the first computing system corresponds to the network action.

12. A method comprising:
at a computing platform comprising at least one processor, a communication interface, and memory:
training, using a plurality of historical thermal images, a thermal image classification model, wherein training the thermal image classification model configures the thermal image classification model to classify thermal images based on performance of systems represented by the thermal images;
collecting current system performance information for a first computing system;
generating, using the current system performance information, a new thermal image, representative of the current system performance information;
classifying, using the thermal image classification model, the new thermal image; and
based on the classification of the new thermal image, sending one or more network action commands, wherein sending the one or more network action commands causes a network traffic manager to redirect traffic from the first computing system to a second computing system.

13. The method of claim 12, wherein the memory stores additional computer-readable instructions that, when executed by the at least one processor, cause the computing platform to:
monitor a plurality of computing systems including the first computing system and the second computing system to detect historical system performance information; and
generate, using the historical system performance information, the plurality of historical thermal images.

14. The method of claim 13, wherein the historical system performance information and the current system performance information comprise one or more of: application performance information, system performance information, or test case results.

15. The method of claim 12, wherein training the thermal image classification model comprises labelling the plurality of historical thermal images based on corresponding system performance, and training the thermal image classification model to identify correlations between the plurality of historical thermal images and the corresponding system performances.

16. The method of claim 12, wherein classifying the current system performance information comprises:
comparing a plurality of image features of the new thermal image to the corresponding image features of the plurality of historical thermal images to identify a highest image matching score, and
selecting a classification corresponding to the highest image matching score.

17. The method of claim 16, wherein the plurality of image features comprise: image peaks and troughs, center of gravity, moment, and spatial frequency.

18. The method of claim 17, wherein comparing the image peaks and troughs comprises comparing one or more of: a number of the image peaks and troughs, or total areas of the image peaks and troughs.

19. The method of claim 16, wherein training the thermal image classification model comprises initially applying equal weighting values to the plurality of image features.

20. One or more non-transitory computer-readable media storing instructions that, when executed by a computing platform comprising at least one processor, a communication interface, and memory, cause the computing platform to:
train, using a plurality of historical thermal images, a thermal image classification model, wherein training the thermal image classification model configures the thermal image classification model to classify thermal images based on performance of systems represented by the thermal images;
collect current system performance information for a first computing system;
generate, using the current system performance information, a new thermal image, representative of the current system performance information;
classify, using the thermal image classification model, the new thermal image; and
based on the classification of the new thermal image, send one or more network action commands, wherein sending the one or more network action commands causes a network traffic manager to redirect traffic from the first computing system to a second computing system.
